(19) United States
(12) Patent Application Publication
(10) Pub. No.: US 2004/0259638 A1
(43) Pub. Date: Dec. 23, 2004

(54) Handheld controller with mouse-type control

(76) Inventors: Dan H. Kramer, Oakhurst, CA (US); Peter Michael Von Buskirk, Northville, MI (US); Phillip James Blankenbaker, Saline, MI (US)

Correspondence Address: LANNY M. ENGLUND, Patent Agent, 1472 Ashover Drive, Bloomfield Hills, MI, 48304, US

(21) Appl. No.: 10/464,327

(22) Filed: Jun. 18, 2003

(51) Int. Cl. A63F 13/00

(52) U.S. Cl. 463/36

(57) ABSTRACT

A handheld controller for interacting with video game software and for use with video game or computer systems comprising a plurality of standard control elements, which produce data of a static nature, further comprising analog joysticks, a directional pad, pressure sensitive buttons, and digital control buttons, having an ergonomic arrangement to be actuated by the fingers and thumbs of the user and integrated into a housing having an ergonomic form designed to held by the hand or hands of the user and further integrating a “mouse-type” control element, which produces data of a dynamic nature.

### BACKGROUND OF THE INVENTION

1. Field of the Invention

The technical field of the present invention is related to a handheld controller for providing control interaction with video game software and more particularly, to a standard handheld controller integrating a “mouse-type” control element, wherein the “mouse-type” element comprises an electromechanical assembly not having a preset range of motion and an electro-mechanical processing means capable of generating data output of a dynamic nature and indicative of a movement by the user and of the control element.

2. Description of the Related Prior Art

The development of devices or systems which run video game software has been segmented into development for PC (personal computers) and for dedicated consoles. PC developers offer devices, which are added to existing computer systems, with dedicated abilities that support the software by increasing its speed or operability. Console hardware developers, by contrast, create fully-operable systems and accessory product devices, dedicated to running video game software in an optimized environment. The accessory product devices include hand controllers, steering wheels, simulation flight sticks (joysticks), and other interactive control devices to interact with the video game software.

U.S. Pat. No. 4,496,936 to Kramer teaches a digital-analog conversion for shaft encoders producing an analog signal having a relative amplitude that is indicative of the direction and rate of shaft rotation. Kramer describes but does not claim a joystick and ball operated mechanism as in the present invention. The Kramer patent was one of the first patents to teach digital-analog conversion for shaft encoders and revolutionized the state of the art in the video game industry.

Over the past 15 years, video game software developers for the PC have supported the mouse and the keyboard as the principal devices for navigation and control. As 3D games emerged, it quickly became the standard on the PC for this new style of game to be controlled by a mouse and keyboard combination. Due to the dynamic nature of a “mouse-type” control, it provides a more intuitive control means by producing data representative of user's movement. No new device has yet been introduced to surpass or even match the speed and precision of that configuration and thus has since remained the standard through the present for control of nearly all video games on the PC.

Each first-party developer of a console system creates a standard basic control set for their own system. Third-party accessory developers for console systems follow suit with controllers that provide the same type of collective control that the first-party developer has. As a typical business practice, third-party accessory developers only release concepts for basic controllers that support the originally intended control interaction of a first-party manufacturer's console system. More specifically, they do not release unique or innovative controller concepts that would change or otherwise enhance the type of control data provided by the basic handheld controller for that system.

In the present state of the art, the basic control configuration for console systems has matured into a standard set of handheld controls of similar configuration across the industry. This standard handheld set is predominately comprised of twelve to sixteen buttons (four of which are arranged into a directional pad or D-pad), two joysticks, and two internal vibration units all integrated into an ergonomic handheld housing. Though producing only static control data, this standard has proven to be of adequate functionality in providing control interaction for the types of video game software developed for console systems. As a result, no further advancements of control, other than a general re-configuration of the ergonomic arrangement, have been made in the past five years.

U.S. Pat. Nos. 5,551,693 and 5,716,274 to Goto, et al teach typical multi-function electronic control devices with a plurality of control sections and switches for use in video game machines and more particularly to a controller unit adapted for three dimensional game applications. A known controller unit for game machines is disclosed in U.S. Pat. No. 5,207,426 adapted for two dimensional game applications. None of the above reference patents disclose or claim the subject matter and novel “mouse-type” control features of the present invention.

There has been a long-felt need both among video game players and software developers in the video game industry to incorporate the speed, precision, accuracy, and intuitive nature of a “mouse-type” control into the basic handheld controller of a console system. This critical need has been further underscored by the recent software development advancements requiring more computer CPU, memory, and game control sophistication to challenge the operator with faster response times, yet while frustrating him with an inadequate hand controller, an inherent disadvantage of the prior art.

In recent generations of console systems, a trackball controller has been made available for a console system. However, the scope of the design was narrowly conceptualized, meaning it was not intended as a solution for the lack of “mouse-type” control and precision accuracy on console systems. The general intention of the controller was to support recently re-released classic arcade games that were written for the trackball. The controller did not provide all of the functions of a standard basic controller, nor was it designed to be held in the hands of a user.

In the history of the related art, first-party hardware developers have found that their basic controllers provide control options that adequately support game software specifically written to be controlled primarily with a “mouse,” otherwise referred to as “mouse-based” games. As a result, it has not been necessary to combine any “mouse-type” control element with a basic handheld controller for console systems. Therefore, there have been no attempts to provide control on a standard console controller that sufficiently parallels the mouse in functionality and data output. To further underscore this point, in the history of the related art, there has never been a controller for any computer or video game system combining “mouse-type” control with other standard controls, specifically in a handheld form.

U.S. Pat. No. 5,929,844 to Barnes teaches and describes a first person perspective control system having a controller for two handed user input of linear and orientation data to control graphical images on a PC computer. The “control-ware” integrates separate “mouse-type” trackballs and/or joysticks and/or force sensitive electronic pads that are designed to be used in conjunction with a typical PC computer system. Barnes teaches and describes, but does not claim the combination of joystick and trackball assemblies into an integrated, handheld housing unit.

The Barnes patent describes and claims joystick and trackball controls but does not teach, describe or claim the novel feature of the subject invention, of integrating “mouse-type” control functions into a standard handheld controller for console systems, which, historically and presently, has a composition of only non-“mouse-type” control elements such as: analog joysticks, a directional pad, pressure sensitive buttons, or digital control buttons, for the purpose of providing handheld mouse support for console systems.

The present invention overcomes the shortcomings and disadvantages of the prior art by providing the unique functionality of “mouse-type” control to console systems in a handheld manner by integrating a trackball or other “mouse-type” control elements into a basic console video game controller. The “mouse-type” control can be incorporated into the controller in a variety of optional ergonomic positions and with multiple modes for additionally emulating other analog devices of the controller.

Also, the present invention enables video game software developers to achieve a more uniform control system when creating software for PC's and console systems, which increases the performance and marketability of their product. Software developers will additionally be able to create new software featuring new and innovative control systems by utilizing the currently unavailable, combined functionality of the present invention.

Still further, the “mouse-type” control feature offered on the present invention will improve the operator response time and intuitive interaction of both present and future software, thereby raising video game performance and customer satisfaction to new levels never before achieved in the prior art of console video game accessories.

### SUMMARY OF THE INVENTION

The present invention is a handheld controller for a video game system, being comprised of a molded housing with integrated control elements mounted on an internal electronic circuit board; similar to standard handheld controllers of the related prior art but providing extended functionality.

It is an object and advantage of the invention to provide a handheld controller having control elements of a conventional handheld controller combined with elements that generate a type of data not found on conventional controllers for interacting with video game software.

It is also an object and advantage of the invention to improve upon any prior, current, or future handheld controller for any prior, current, or future video game or computer system by integrating a “mouse-type” control element, a configuration not presently available and a definite advantage over the prior art.

It is also an object and advantage of the invention to provide support of mouse functions on console systems in a basic handheld controller, or otherwise to provide “mouse-type,” dynamic control data together with the non-“mouse-type,” static control data of a standard handheld controller in a single handheld controller for console systems.

It is also and object and advantage of the invention to provide a handheld controller that can be created in multiple embodiments, where each embodiment may have varying ergonomic form of the housing and/or varying arrangement or quantity of the control elements. Further, each embodiment may be designed to interact with various specific computer systems or video game console systems and with varying features, which may include wired or wireless connectivity or other features or functions common among the related prior art.

It is an advantage of the invention that it can provide a more uniform and intuitive standard of control for the user than is provided by the prior art. It is also an advantage of the present invention that it can provide a more uniform set of control functions across multiple software platforms; these platforms being various console systems and PC (personal computer) systems, where versions of the same software exist on several. This is a further advantage to software developers by enabling a more exact translation of the original software functionality between platforms.

It is also an object and advantage of the present invention to provide the expanded functionality of a “mouse-type” control element on a handheld controller whether it be a standard handheld controller or a handheld controller featuring other types of expanded functionality, which may include wired or wireless connectivity or other features or functions common among the related prior art. Further, it is an object to provide this in a ergonomic form and arrangement that is designed to be held and actuated by the hand or hands of the user.

These and other advantages, features and objects of the invention will become apparent from the drawings, detailed description, and claims which follow.

### BRIEF DESCRIPTION OF THE DRAWINGS

FIG. 1 is a block diagram of the handheld video game controller unit and system comprised of Blocks A1 through A7 while inter-relating the directional pad (D-pad) A1; joystick control functions A2,A3; pressure sensitive control button switches A4; digital control button switches A5; the trackball assembly and related circuitry A6; and data encoder communications interface A7; video game console A9; and video image display A8;

FIG. 2 is a block diagram of the trackball circuitry expansion of Block A6 of FIG. 1 further comprising both the “additional control element” of the trackball apparatus, and the signal processing and mode control circuitry illustrated by Blocks B1 through B6; wherein B1 is the Trackball Electro-mechanical Assembly; B2 is the Digital Signal Processing Data Separation; B3 is the Digital-Analog Signal Conversion; B4 is the D-pad Emulation; B5 is the Analog Device Switcher; and B6 is the Output Signal Mode Control Multiplexer;

FIG. 3 is a top plan view of the video game controller unit (1) having an integral housing (3) and including a first grip (4), and a second grip (5), extending from opposite longitudinal ends of the housing (3), selector switches (7), and start switch (8) provided at the narrow center of housing (3), first and second control sections (9) and (11) including a plurality of switches,and third and fourth control sections (29) and (30), symmetrically provided at the front side of the housing(3), a joystick controller (12), and a trackball “mouse-type” control element (14);

FIG. 4 is a front view of the controller unit as shown in FIG. 3 with the first grip (4) and second grip (5), the joystick controller (12), and the trackball control element (14);

FIG. 5 is a perspective view of the controller unit as shown in FIG. 3, showing the first and second control sections (9) and (11); first grip (4) and second grip (5), joystick controller (12), and the trackball control element (14);

FIG. 6 is a perspective view of the controller unit also illustrating the first and second control sections (9) and (11), the joystick controller (12), the trackball element (14), and third and fourth control sections (29) and (30) symmetrically provided at the front side of the housing (3).

FIG. 7, in a top plan view, and FIG. 8, in a front view, show an alternative configuration with the “mouse-type” trackball element (14) positioned equidistant and aft of the centerline between dual joystick controls (12) and first (4) and second (5) hand grips on the top portion of the housing.

### DETAILED DESCRIPTION OF THE PREFERRED EMBODIMENT

The present invention is particularly related to a “mouse-type” control element such as a trackball used in conjunction with left or right joystick controllers (12) and the accessory controls and control button switches in the first and second control sections (9) and (11), and the third and fourth control sections (29) and (30) of a conventional handheld video game controller as shown in FIG's 3,4,5 &6.

The ergonomic form and arrangement of the control elements of the handheld controller depicted in the drawings FIG's (3-8) bears similarity to a specific present generation basic controller for purposes of visual reference.

In the preferred embodiment of the invention, the “right hand thumb” actuated trackball “mouse-type” control element (14) is in the right-hand position adjacent to the second grip (5) as shown in FIG's 3,4, and 5. However, the trackball or other “mouse-type” control element can be integrated in any position on the controller to be ergonomically actuated with the thumbs or fingers of the user, in either the left or right hand position, or in the fore or aft position with one or more joystick controllers.

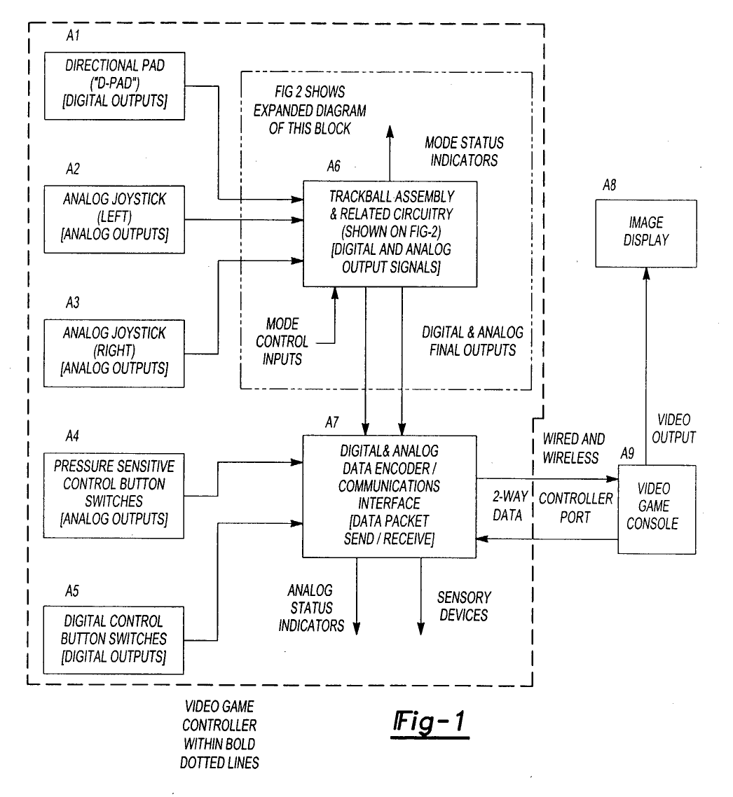

The block diagrams of FIGS. 1 & 2 provide visualization of a typical game controller enhanced by the “mouse-type” trackball assembly and related circuitry of the preferred embodiment of the present invention.

The handheld video game controller is shown in the block diagram flow chart of FIG. 1 and is comprised of blocks A1 through A7, contained within the outer dashed lines. The video game console system is defined by Block A9 in conjunction with Blocks A1-A7 and A8 comprising the entire game controller, video game console, and video image display.

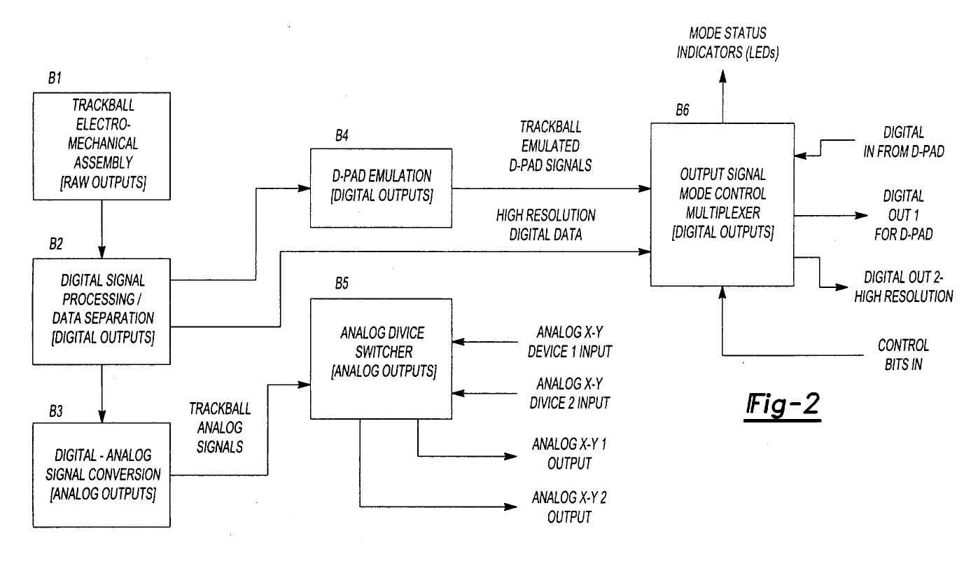

The Directional Pad (D-pad) is illustrated by Block A1. Blocks A2 and A3 are referred to as Analog Joystick (Left or Right). Block A4 is referred to as the Pressure Sensitive Control Button Switches. The Digital Control Button Switches are referred to in Block A5. Block A6 defines the Trackball Assembly and related circuitry and is further detailed in Blocks B1 to B6 of FIG. 2 describing the preferred embodiment of the present invention.

The “mouse-type” additional control element of the trackball apparatus is illustrated by Block A6 of FIG. 1 and by the signal processing and mode control circuitry illustrated by Blocks B2 through B6 in FIG. 2 to accomplish the following functions:

A. Produce high-resolution data that is indicative of speed and direction of movement of the trackball or other “mouse-type” control element.

B. Accept similar control-related electronic signals from outlying control elements A1 through A3, for selection and routing to the Data Encoder/Communications Interface A7

C. Translate trackball signal data into various electronic data modes, which can be then interpreted by the video game console software in a manner that will improve, optimize or maximize the control response best suited for that video game software.

D. Allow the user to select a preferred combination of control elements or modes of emulation that are then inputted to the circuitry shown in FIG. 2 as B5 and B6, from points of origin A1 through A3, and trackball elements contained within A6 of FIG. 1. This is done with either assigned control button switches as in Block A5, or with independent, separate control button switches.

E. Provide user control configurations that, in interacting with the video game console software, are not provided as software menu options in the game program, such that additional methods of improved control are available which will allow for more precise control and performance in the game.

F. Provide visual indication to the user of the selected mode(s) via illuminated status indicators (LEDs) in order to maximize the user's awareness of the controller's active configuration.

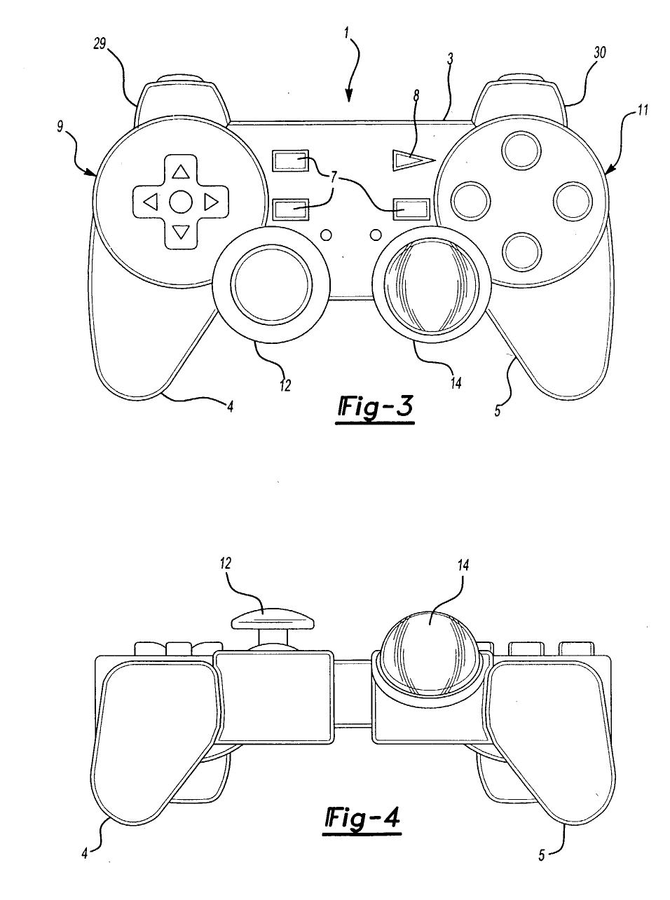

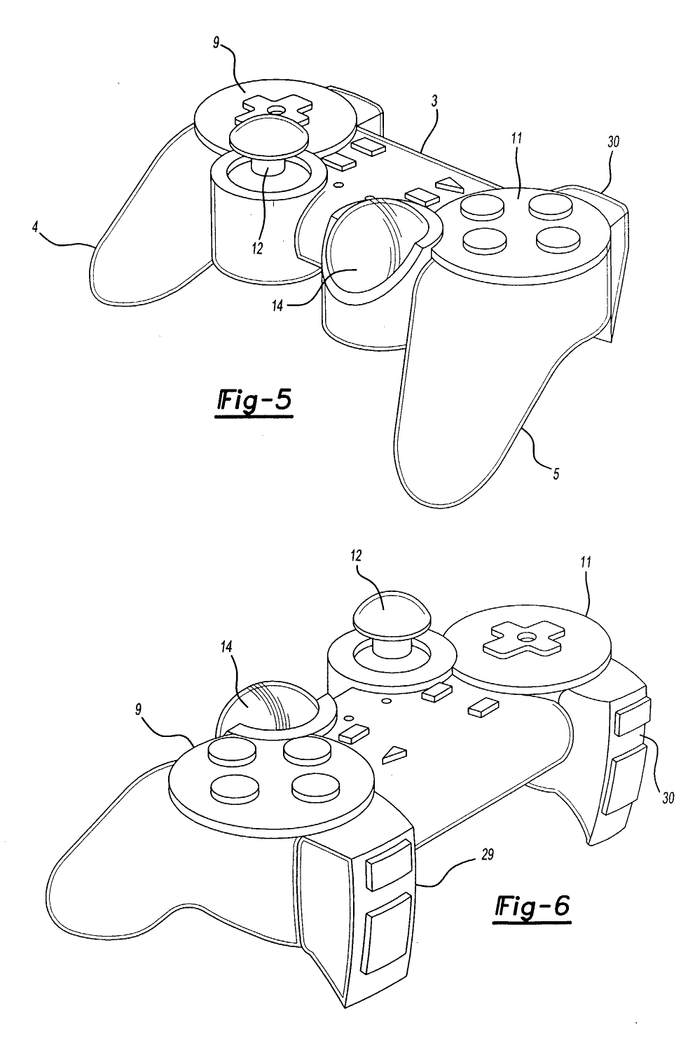

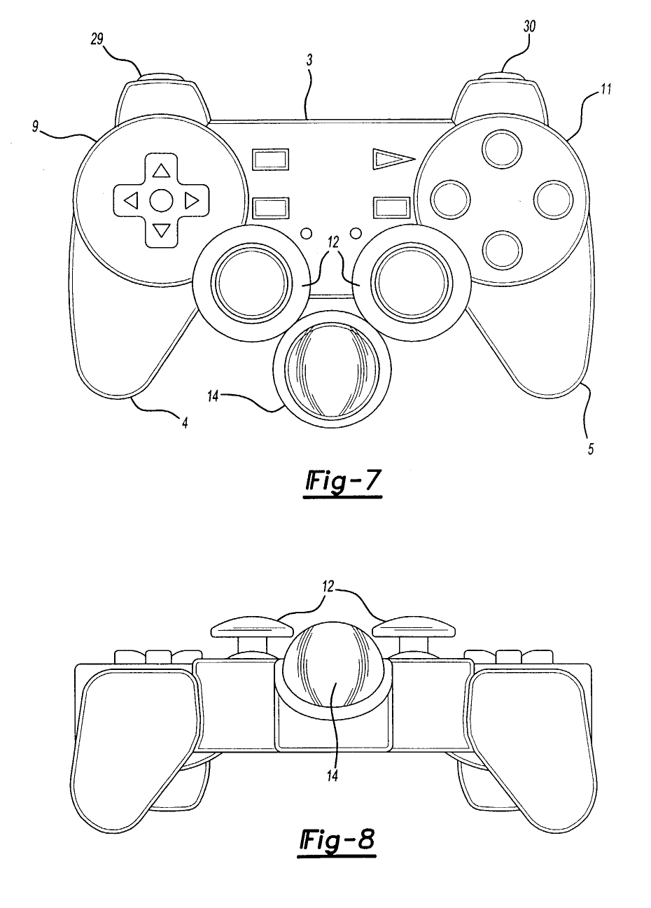

The preferred embodiment of the handheld video game controller in the subject invention is shown in the plan view of FIG. 3, front view of FIG. 4, and in the perspective views of FIG. 5, and FIG. 6. The video game controller of unit (1) comprising: an integral housing (3); first, left-hand grip (4) and second, right-hand grip (5) extending from opposite longitudinal ends of the housing (3); selector switches (7) and start switch (8) provided at the center portion section of the housing (3), first and second control sections (9) and (11) including a plurality of switches, and third and fourth control sections (29) and (30), symmetrically provided at the front side of the housing (3), a joystick controller (12), and the trackball “mouse-type” control element (14).

The trackball “mouse-type” control element (14) is engaged with the “right hand thumb” in the preferred embodiment of FIG's (3-6) and is positioned adjacent to the second grip (5), with the left-hand joystick control (12) positioned left of the trackball (14) and adjacent to the first grip (4). The trackball control element (14) could alternatively be positioned adjacent to the first grip (4) with the joystick control(12) positioned to the right and adjacent to the second grip (5) for “left-hand thumb” engagement and actuation of the trackball (14). Also, in an alternative configuration, the trackball (14) could be positioned aft of the centerline between dual joystick controls (12) as shown in FIG's 7 and 8, or in any position on the housing.

1. A handheld video game controller with “mouse-type” control comprising:
(a) an integral base unit housing ergonomically designed to be held by a hand of an operator; and
(b) a plurality of control elements integrated into the housing and ergonomically arranged to be actuated with thumbs and fingers of an operator's hand.

2. A handheld video game controller with “mouse-type” control further comprising:
(a) an integral base unit housing ergonomically designed to be held by the hands of an operator having opposite longitudinal ends with a center portion;
(b) at least one hand grip extending from one of the opposite longitudinal ends of the housing; and
(c) a plurality of control elements integrated into the housing and ergonomically arranged to be actuated with thumbs and fingers of an operator's hand.

3. A handheld video game controller according to claims 1 or 2, wherein, the plurality of control elements comprises a combination of both static-type and dynamic type control data producing elements, which provide interactive control of video game software.

4. A handheld video game controller according to claims 1 or 2, wherein the plurality of control elements may include any number of buttons for providing digital control output indicative of the position of the button.

5. A handheld video game controller according to claims 1 or 2, wherein the plurality of control elements may include any number of pressure-sensitive buttons for providing analog control output indicative of the amount of pressure applied to the button.

6. A handheld video game controller according to claims 1 or 2, wherein the plurality of control elements may include any number of joystick components for providing analog control output indicative of the position of the joystick in two axes.

7. A handheld video game controller according to claims 1 or 2, wherein the plurality of control elements may include any number of “mouse-type” control elements, and wherein the “mouse-type” control elements may be 1 or more trackballs for providing control output indicative of the movement of the trackballs in two axis.

8. A handheld video game controller according to claims 1 or 2, wherein any of the “mouse-type” control elements may be any control element capable of generating signal data indicative of a movement.

9. A handheld video game controller according to claims 1 or 2, wherein the composition is similar and compatible with any specific standard handheld controller for interacting with video game software operating on a video game computer system while providing more intuitive and precise control.

10. A handheld video game controller with a “mouse-type” control comprising:
(a) an integral base unit housing having opposite longitudinal ends with a center portion, a top portion, a back portion, and a front portion;
(b) first left-hand and second and right-hand ergonomic hand grips extending from the opposite longitudinal ends of the housing having top and front portions;
(c) selector and start switches provided at the center of the housing;
(d) first and second control sections further including a plurality of switches disposed on the top portion of the integral base unit and positioned above the first and second hand grip top portions;
(e) third and fourth control sections symmetrically provided at the front side portion of the housing and disposed in the front portions of the first and second hand grips;
(f) a joystick control element positioned adjacent to and above the top portion of the left-hand grip;
(g) a trackball providing the “mouse-type” control element positioned adjacent to and above the top portion of the right-hand grip and the center portion on the top portion of the-integral base unit housing.

11. The handheld video game controller with a “mouse-type” control according to claim 10, wherein the trackball is positioned adjacent to and above the top portion of the left-hand grip and wherein the joystick control element is positioned adjacent to and above the top portion of the right-hand grip.

12. The handheld video game controller with a “mouse-type” control according to claim 10, wherein the trackball is positioned forward of, and at the center of the intersection line of centers between two joystick control elements, located on the top portion and above the center portion of the base unit housing, and above the first and second handgrips currently used on a typical video game controller configuration.

13. The handheld video game controller with a “mouse-type” control according to claim 10, wherein the trackball is positioned to the rear of and at the center of the intersection line of centers between two joystick control elements, located on the top portion and above the center portion of the base unit housing, and above the first and second handgrips currently used on a typical video game controller configuration.

14. The handheld video game controller with a “mouse-type” control element according to claim 10, wherein the trackball can be located in any position on the base unit housing in conjunction with any number of joystick control elements and any number of other control elements.

15. A handheld electronic video game controller for a video game computer system comprising:
(a) signal means provided for a directional pad with digital outputs;
(b) joystick signal means provided with analog outputs linked with said directional pad digital outputs;
(c) mode control input means;
(d) trackball “mouse-type” control element electro-mechanical assembly means providing electronic data that is processed into digital and analog outputs;
(e) signal means provided by pressure sensitive control button switches with analog outputs;
(f) signal means provided by digital control button switches with digital outputs; and
(g) a digital and analog data encoder communications interface accepting control-related signals from the trackball “mouse-type” control element electro-mechanical assembly electronic circuitry, in combination with the analog outputs of the pressure sensitive control button switches and the digital outputs of the digital control button switches, wherein said data encoder interface has an analog output to both analog status indicators and sensory device motors, as well as a 2-way data communications interface with a video game console.

16. The handheld electronic video game controller for a video game computer system of claim 15, wherein the trackball “mouse-type” control element assembly means further comprises:
digital signal processing and data separation means; combined with trackball emulated D-Pad signal means; and high resolution digital data means translated into an output signal mode control multiplexer with mode status indicators, digital D-Pad outputs, and high resolution digital outputs.

17. The handheld electronic video game controller system of claim 15, wherein the trackball “mouse-type” control element assembly means further comprises:
digital-analog signal conversion means translating trackball analog signals for processing with analog device switcher means having analog device X-Y inputs, and analog device X-Y outputs.

18. The handheld electronic video game controller system of claim 15, wherein the digital and analog data encoder communications interface provides a wireless 2-way data communications interface with the video game console.

19. The handheld electronic video game controller system of claim 15, wherein the digital and analog data encoder communications interface provides a wireless 2-way data communications interface with a computer.

20. A method of providing a handheld video game controller with a “mouse-type” control element, wherein the “mouse-type” control element is a trackball and trackball electro-mechanical assembly, which comprises:
producing high-resolution data that is indicative of speed and direction of movement of the trackball;
accepting similar control-related electronic signals from outlying control elements including directional pad outputs and analog joystick (left and right) analog outputs for eventual selection and routing to the data encoder and communications interface;
translating trackball signal data into a number of variable electronic modes of data output which can be interpreted by the video game software in a manner that will optimize, improve, and maximize the control response best suited to the format of that video game software; and
allowing the user to select a preferred combination of control elements from those inputted into the trackball assembly and related circuitry, that are then processed via an output signal mode control multiplexer, and with output into the data encoder and 2-way communications interface, to the video game computer system.

21. The method of claim 20, wherein the trackball assembly and related circuitry further comprises:
producing raw digital outputs from a trackball electro-mechanical assembly for separation into signals for processing into trackball emulated D-pad signals; for separation into high resolution digital data signals, both to be input into the output signal mode control multiplexer with digital outputs; and for separation for digital-analog signal conversion into trackball analog signals for input into an analog device switcher with analog x-y inputs and x-y outputs.

22. The method of claim 20, wherein the “mouse-type” control element can be represented in any physical form, and wherein the “mouse-type” control element electro-mechanical assembly processing means is capable of generating data output of a dynamic nature and indicative of a movement.
